(19) United States
(12) Patent Application Publication
(10) Pub. No.: US 2016/0054835 A1
(43) Pub. Date: Feb. 25, 2016

(54) TOUCH SCREEN INTEGRATED DIGITIZER USING THREE DIMENSIONAL MAGNETISM SENSOR AND MAGNETIC PEN

(71) Applicant: TRAIS CO., LTD., Gyeonggi-do (KR)

(72) Inventors: Seong Hwan HEO, Daejeon (KR); Hyung Kwon SEO, Seoul (KR); Hong Chae KIM, Ansan-si (KR); Kwang Gu LEE, Ansan-si (KR)

(73) Assignee: TRAIS CO., LTD., Gyeonggi-do (KR)

(21) Appl. No.: 14/781,231

(22) PCT Filed: May 16, 2014
(86) PCT No.: PCT/KR2014/004406

§ 371 Date: Sep. 29, 2015

(30) Foreign Application Priority Data
Feb. 21, 2014 (KR) 10-2014-0020331
Apr. 24, 2014 (KR) 10-2014-0049381

(51) Int. Cl. G06F 3/046; G06F 3/0354; G09G 3/36; G06F 3/041

(52) U.S. Cl. CPC G06F 3/046; G06F 3/0412; G06F 3/03545; G09G 3/36; G06F 2203/04101

(57) ABSTRACT

Provided is a touch screen integrated digitizer including a three-axis magnetic force sensor and a magnetic pen, which measures a distribution and a change amount of a magnetic force vector, generated by moving the magnetic pen generating a magnetic force, to accurately sense a position of the magnetic pen which is moved on a touch screen. Since the digitizer for detecting position information of an external input unit is implemented with a magnetic force sensor installed at an internal edge of a display device, a separate digitizer panel is not provided, and thus, the display device is lightened and slimmed.

### TECHNICAL FIELD

The present invention relates to a touch screen integrated digitizer including a three-axis magnetic force sensor and a magnetic pen, and more particularly, to a touch screen integrated digitizer including a three-axis magnetic force sensor and a magnetic pen, which measures a distribution and a change amount of a magnetic force vector, generated by moving the magnetic pen generating a magnetic force, to accurately sense a position of the magnetic pen which is moved on a touch screen.

### BACKGROUND TECHNOLOGY

Digitizers are a type of an input device applied to display apparatuses and denote apparatuses that have a matrix-type electrode structure, read X and Y coordinates of a matrix according to a pen or a cursor being moved by a user to transfer a position signal of an input device to a controller, thereby executing a command corresponding to the position signal.

The digitizers are called touch panels or tablets in a broad sense and are categorized into resistive digitizers, capacitive digitizers, magnetic digitizers, etc. depending on a position detection method. Depending on the case, the digitizers are used separately from the touch panels.

A display device, included in display apparatuses such as mobile communication terminals, tablet personal computers (PCs), etc., includes a cover glass, a touch panel, a liquid crystal panel, and a digitizer. With the advancement of display industry, display devices where the elements are integrated as one body or are separately provided have been proposed.

However, when a touch screen digitizer is implemented by separately installing a magnetic force sensor panel, the number of panels bonded to each other increases, and for this reason, a structure of an apparatus becomes complicated, and the manufacturing cost increases. Also, when an error occurs, it is difficult to perform repair or replacement.

### Technical Solutions

Accordingly, the present invention provides a touch screen integrated digitizer including a three-axis magnetic force sensor and a magnetic pen, which includes one or more magnetic force sensors disposed in a digitizer coupled to a touch screen and senses a change in a magnetic field caused by movement of a the magnetic pen to detect position information and movement information of the magnetic pen.

The present invention also provides a touch screen integrated digitizer including a three-axis magnetic force sensor and a magnetic pen, which includes a device disposed in the magnetic pen to generate a magnetic force and adjusts a three-dimensional (3D) distribution of the generated magnetic force to increase a degree of precision of detection.

In one general aspect, a touch screen integrated digitizer, including a three-axis magnetic force sensor and a magnetic pen, includes: a display device; and a magnetic pen, wherein the display device includes: a cover window configured to protect the display device from an external contact damage caused by a touch or writing; a touch panel disposed on a rear surface of the cover window to sense a touch contact signal; a liquid crystal panel disposed on a rear surface of the touch panel to output signal information; a circuit board configured to control an input or an output of a signal to or from the touch panel, the liquid crystal panel, and a magnetic force sensor; an internal case configured to surround a side surface and a rear surface of the circuit board and accommodate the cover window, the touch panel, and the liquid crystal panel which are sequentially stacked; and a magnetic force sensor provided as one or more on one of the rear surface of the cover window, a front surface and the rear surface of the liquid crystal panel, a front surface and the rear surface of the touch panel, a front surface and the rear surface of the circuit board, and an inner surface of the internal case, and the magnetic pen freely moves on the front surface of the cover window to generate a three-dimensional (3D) distribution of a magnetic force, the magnetic force sensor detects the 3D distribution of the magnetic force, and the display device visually displays a movement trajectory.

The cover window may be a sheet that includes a front surface and a rear surface which are flat or includes a flat surface whose a portion is bent at a curvature of 1 cm to 50 cm, and has a thickness of 0.1 mm to 10 mm.

The cover window may be formed of a transparent material having a light transmittance of 85% to 95%, the transparent material being one of Pyrex glass, soda glass, alumina glass, quartz, poly methyl methacrylate (PMMA), an acryl-based polymer composite, polyethylene terephthalate (PET), or the cover window may be formed of one material of an acryl-based polymer, a vinyl-based polymer, and a terephthalate-based polymer, in which the polymer molecular binding of a surface is reinforced by applying electrons of 1 keV to 10,000 keV, ions, gamma rays to the surface.

The touch panel may include a touch sensing electrode, which is formed of one material of indium tin oxide (ITO), silver nanoparticles, silver nanowire, and carbon nanotube which have a light transmittance of 85% to 99% and are transparent, and a lateral axis supporting layer and a longitudinal axis supporting layer, which are each formed of one material of poly methyl methacrylate (PMMA), an acryl-based polymer composite, polyethylene terephthalate (PET), may be covered by the front surface of the liquid crystal panel. Also, a lateral axis pattern layer may be cross-coupled to the lateral axis supporting layer with respect to a longitudinal axis pattern layer and the longitudinal axis supporting layer.

The magnetic force sensor may measure magnetic forces of 0.001 Gauss to 10,000 Gauss in three axis directions of spatial orthogonal coordinates by using a hall effect, a search coil induction effect, a flux gate induction effect, and a magneto resistive effect.

The circuit board may previously store three-axis magnetic force distribution data of the magnetic pen based on front coordinates of the display device, and the display device may compare the previously stored three-axis magnetic force distribution data with a three-axis magnetic force vector measured based on a free movement of the magnetic pen to calculate a relative trajectory of the magnetic pen.

The three-axis magnetic force distribution data may be a unique distribution measured by each of the one or more magnetic force sensors included in the display device, and the display device may calculate an arithmetic average of trajectories of the magnetic pen sensed by two or more magnetic force sensors to enhance an accuracy of a trajectory.

Other features and aspects will be apparent from the following detailed description, the drawings, and the claims.

### Advantageous Effects

As described above, according to the embodiments of the present invention, since the digitizer for detecting position information of an external input unit is implemented with the magnetic force sensor installed at the internal edge of the display device, a separate digitizer panel is not provided, and thus, the display device is lightened and slimmed.

### DESCRIPTION OF DRAWINGS

FIG. 1 is an exploded perspective view illustrating a structure of a digitizer according to a first embodiment of the present invention.

FIG. 2 is a plan view illustrating a structure of a touch panel.

FIG. 3 is a cross-sectional view illustrating an internal structure of the touch panel of FIG. 2.

FIG. 4 is a perspective view illustrating a position of a magnetic force sensor of a digitizer according to a second embodiment of the present invention.

FIG. 5 is a perspective view illustrating a position of a magnetic force sensor of a digitizer according to a third embodiment of the present invention.

FIG. 6 is a conceptual diagram illustrating a method of detecting, by a digitizer, a 3D magnetic-force line generated by a magnetic pen to calculate a position of the magnetic pen.

FIG. 7 is a conceptual diagram illustrating a structure of a 3D magnetic-force line generated by a magnetic pen.

FIG. 8 is a perspective view illustrating an internal structure of a magnetic force sensor.

FIG. 9 is a graph showing a spatial distribution of a magnetic force in an X-axis direction generated by a magnetic pen.

FIG. 10 is a graph showing a spatial distribution of a magnetic force in a Y-axis direction generated by the magnetic pen.

FIG. 11 is a graph showing a spatial distribution of a magnetic force in a Z-axis direction generated by the magnetic pen.

FIG. 12 is a plan view illustrating a plurality of magnetic force sensors which are arranged in parallel depending on a size of a digitizer.

### BEST MODE

Hereinafter, a touch screen integrated digitizer (hereinafter referred to as a digitizer) including a three-axis magnetic force sensor and a magnetic pen according to embodiments of the present invention will be described in detail with reference to the accompanying drawings.

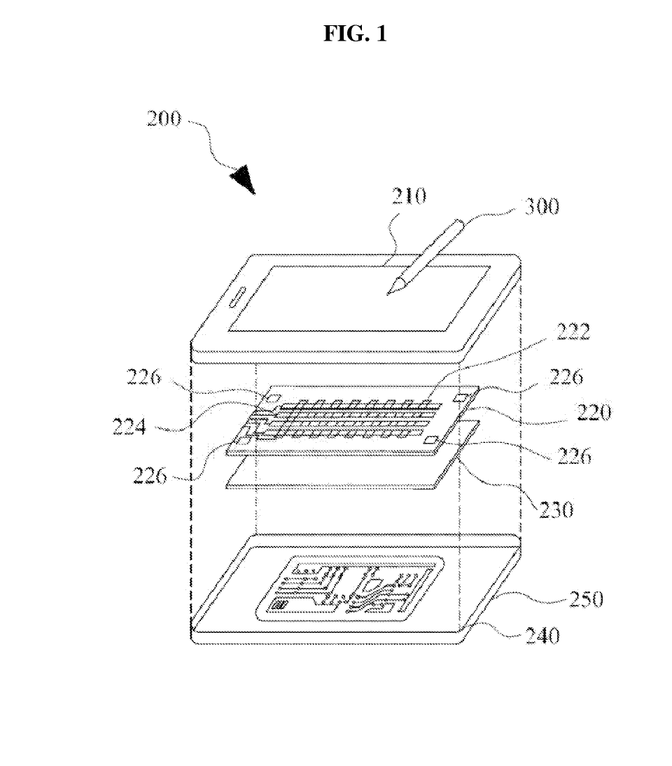

FIG. 1 is an exploded perspective view illustrating a structure of a digitizer according to a first embodiment of the present invention.

The digitizer according to the first embodiment of the present invention may include a display device 200, which displays an image signal and measures a distribution of a magnetic force, and a magnetic pen 300 that moves on the display device 200 and generates a 3D distribution of a magnetic force.

The display device 200 may include: a cover window 210 that protects the display device 200 from an external contact damage caused by a touch or writing; a touch panel 220 that is disposed on a rear surface of the cover window 210 to sense a touch contact signal; a liquid crystal panel 230 that is disposed on a rear surface of the touch panel 220 to output signal information; a circuit board 240 that controls an input/output of a signal to/from the touch panel 220, the liquid crystal panel 230, and a magnetic force sensor 226; an internal case 250 that surrounds a side surface and a rear surface of the circuit board 240 and accommodates the cover window 210, the touch panel 220, and the liquid crystal panel 230 which are sequentially stacked; and a magnetic force sensor 226 that is disposed on one or more positions of the rear surface of the cover window 210, a front surface and the rear surface of the liquid crystal panel 230, a front surface and the rear surface of the touch panel 220, a front surface and the rear surface of the circuit board 240, and an inner surface of the internal case 250, in the display device 200.

Moreover, the magnetic pen 300 may freely move on the front surface of the cover window 210 to generate a 3D distribution of a magnetic force. The magnetic force sensor 226 may detect the 3D distribution of the magnetic force, and the display device 200 may visually display a movement trajectory.

The cover window 210 may be a sheet that includes a front surface and a rear surface which are flat or includes a flat surface whose a portion is bent at a curvature of 1 cm to 50 cm, and has a thickness of 0.1 mm to 10 mm. The cover window 210 may be formed of a transparent material having a light transmittance of 85% to 95%, and for example, may use, as a base material, one of Pyrex glass, soda glass, alumina glass, quartz, poly methyl methacrylate (PMMA), an acryl-based polymer composite, polyethylene terephthalate (PET). Depending on the case, the cover window 210 may be formed of one of an acryl-based polymer, a vinyl-based polymer, and a terephthalate-based polymer, in which the polymer molecular binding of a surface is reinforced by applying electrons of 1 keV to 10,000 keV, ions, gamma rays to the surface.

The magnetic force sensor 226 may be provided as one or more at an edge (an inactive area of the liquid crystal panel 230) of a transparent substrate of the touch panel 220 and may detect a magnetic field which is generated on the front surface of the touch panel 220. At this time, the magnetic force sensor 226 may be connected to a power supply and may be supplied with power, for detecting the magnetic field.

Moreover, the magnetic force sensor 226 may sense a change in a magnetic field, which is caused on the front surface of the touch panel 220 by the magnetic pen 300, to detect position information and may transfer the position information to a controller of the display device 200. In this case, the magnetic force sensor 226 may include an analog-to-digital (A/D) converter that converts an analog signal into a digital signal.

The magnetic force sensor 226 may measure magnetic forces of 0.001 Gauss to 10,000 Gauss in three axis directions of spatial orthogonal coordinates by using a hall effect, a search coil induction effect, a flux gate induction effect, and a magneto resistive effect.

The magnetic force sensor 226 may have a horizontal size, a vertical size, and a height of 0.1 mm to 100 mm.

The magnetic force sensor 226 may be a device that a 3D magnetic force vector and a change amount of the 3D magnetic force vector by using the hall effect where a current flowing between parallel electrodes is leaked in a vertical direction due to an external magnetic field, a search coil method where a conductor is wound around an outer circumference of a cylinder-shaped magnetization coil and thus an induced current is generated according to Faraday's law, and the magneto resistive effect where a resistance of a flowing current increases when a conductive layer magnetized in a certain direction is coupled to another conductive layer magnetized in a reverse direction. The magnetic force sensor 226 may sense in real time magnetic force vectors which are simultaneously changed according to a distance vector of the magnetic pen 300, thereby calculating a relative distance vector between the magnetic force sensor 226 and the magnetic pen 300.

When the magnetic pen 300 moves on the front surface of the display device 200, if a relative distance vector increases, magnetic force vectors (Bx, By, Bz) may be reduced, and moreover, the magnetic force vectors may be simultaneously changed in a one-to-one correspondence relationship along spatial orthogonal coordinates (X axis, Y axis, Z axis). Therefore, relative spatial coordinates of the magnetic pen 300 to the magnetic force sensor 226 may be measured by measuring a vector of a magnetic force signal. When desiring to determine a relative position of the magnetic pen 300, spatial coordinates which the measured magnetic force vector represents may be calculated because a spatial distribution of a magnetic force which is sensed when the magnetic pen 300 freely moves on spatial coordinates is previously input to the controller of the display device 200. When desiring to a more accurate position, the magnetic force sensor 226 may be provided in plurality, spatial coordinates and a distance vector from each of the magnetic force sensors 226 to an object to be measured may be calculated, and an absolute position of the object may be detected within an error range of 0.1 mm to 5 mm by calculating an arithmetic average of a plurality of calculation values. Alternatively, the measured distance vector and magnetic force vector may be respectively converted into an absolute distance and an absolute magnetic-force intensity, and then, a relative position of the magnetic pen 300 between two or more magnetic force sensors 226 may be detected according to a triangular measurement method.

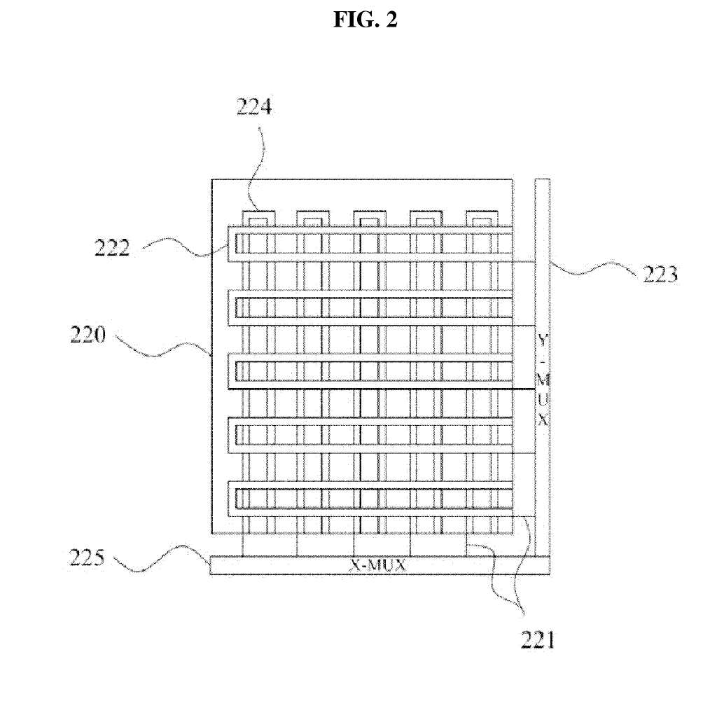

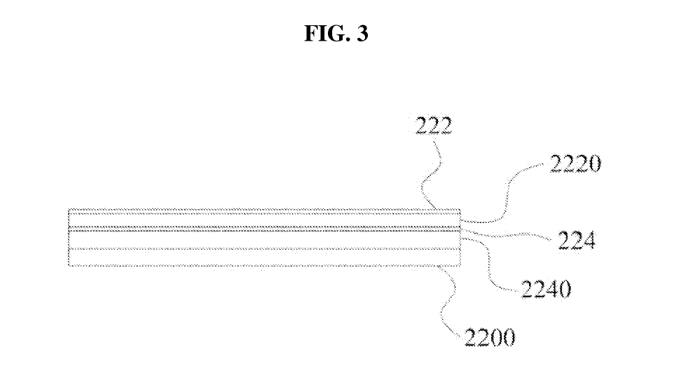

FIG. 2 is a plan view illustrating a structure of a touch panel. FIG. 3 is a cross-sectional view illustrating an internal structure of the touch panel of FIG. 2.

As illustrated in FIGS. 2 and 3, the touch panel 220 may include a touch sensing electrode, which is formed of one material of indium tin oxide (ITO), silver nanoparticles, silver nanowire, and carbon nanotube which have a light transmittance of 85% to 99% and are transparent, and a plurality of electrode supporting layer 2220 and 2240 which are each formed of one material of poly methyl methacrylate (PMMA), an acryl-based polymer composite, polyethylene terephthalate (PET). The plurality of electrode supporting layers 2220 and 2240 may be covered by the front surface of the liquid crystal panel 230. Also, the touch sensing electrode may be disposed on a lateral axis pattern layer 222 and the electrode supporting layer (a lateral axis supporting layer) 2220, and the lateral axis pattern layer 222 may be cross-coupled to the lateral axis supporting layer 2220 with respect to a longitudinal axis pattern layer 224 and the electrode supporting layer (a longitudinal axis supporting layer) 2240. The touch panel 220 may sense a pressure change, a capacitance change, or a contact resistance change caused by a conductive or nonconductive material contact applied to an upper portion of a pattern.

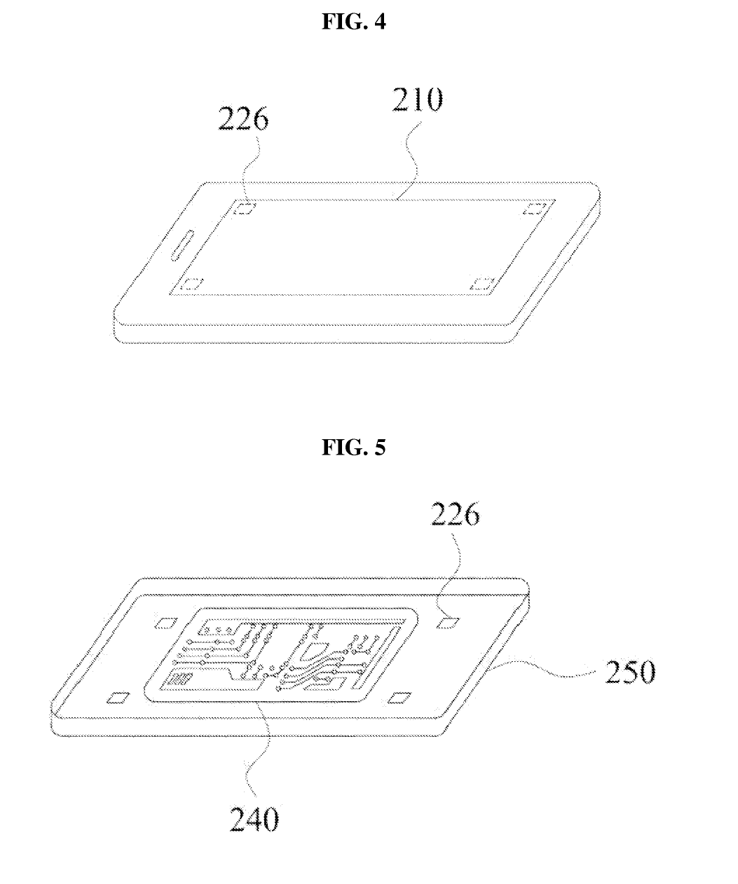

FIG. 4 is a perspective view illustrating a position of a magnetic force sensor of a digitizer according to a second embodiment of the present invention. FIG. 5 is a perspective view illustrating a position of a magnetic force sensor of a digitizer according to a third embodiment of the present invention.

The magnetic force sensor 226 may be provided as one or more in upper, lower, left, and right marginal spaces of the touch panel 220 or a marginal space of the rear surface of the liquid crystal panel 230. However, depending on the case, as illustrated in FIG. 4, the magnetic force sensor 226 may be provided as one or more in upper, lower, left, and right marginal spaces of the cover window 210.

Moreover, as illustrated in FIG. 5, the magnetic force sensor 226 may be provided as one or more on the front surface and rear surface of the circuit board 240 or an internal surface of the internal case 250.

One magnetic force sensor 226 may sense a 3D magnetic force vector generated by the magnetic pen 300, and the display device 200 may calculate relative spatial coordinates between the magnetic pen 300 and the magnetic force sensor 226, whereby more accurate relative spatial coordinates may be calculated by comparing calculation values obtained by two or more magnetic force sensors 226.

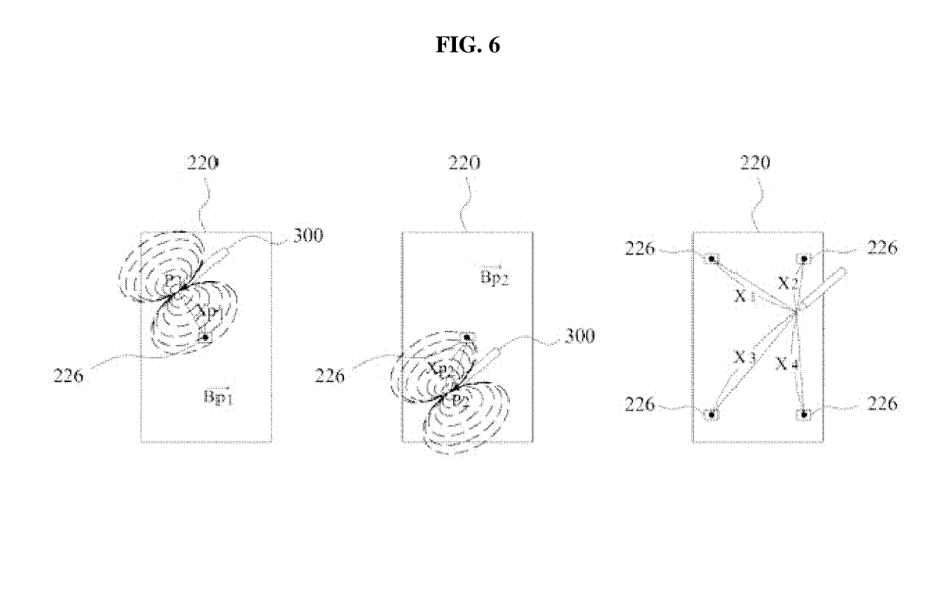

FIG. 6 is a conceptual diagram illustrating a method of detecting, by a digitizer, a 3D magnetic-force line generated by a magnetic pen to calculate a position of the magnetic pen.

As illustrated in FIG. 6, the magnetic force sensor 226 may measure magnetic forces of 0.001 Gauss to 10,000 Gauss in three axis directions of spatial orthogonal coordinates by using the hall effect, the search coil induction effect, the flux gate induction effect, and the magneto resistive effect.

The display device 200 may previously store, in the circuit board 240, three-axis magnetic force distribution data of the magnetic pen 300 based on front coordinates and may compare the previously stored three-axis magnetic force distribution data with a three-axis magnetic force vector measured based on a free movement of the magnetic pen 300 to display a relative trajectory of the magnetic pen 300 as visual data on the front surface of the display device 200.

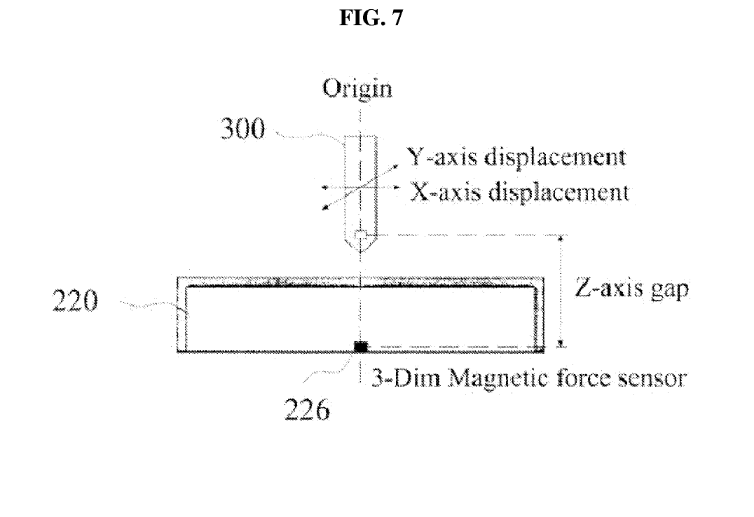

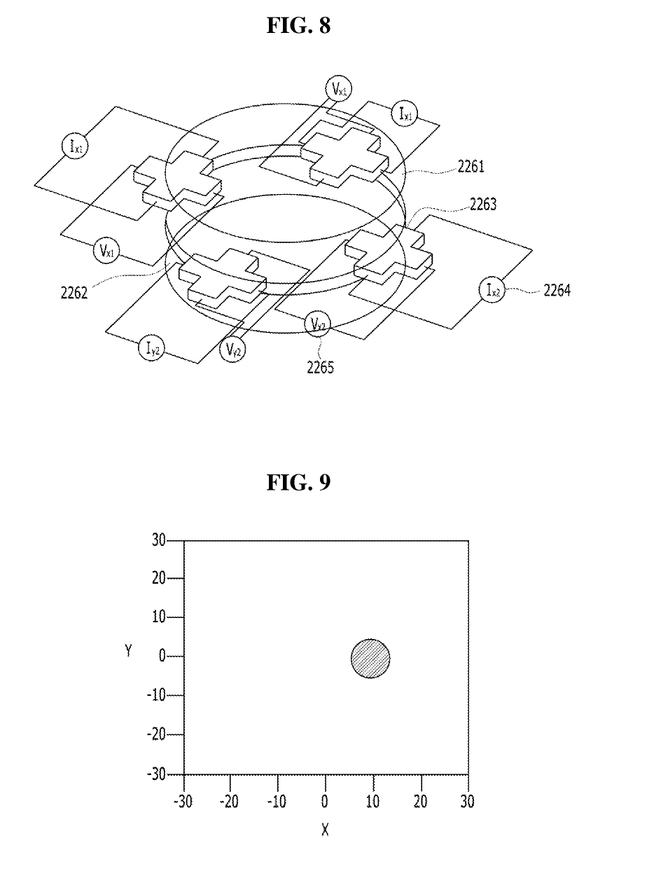

FIG. 7 is a conceptual diagram illustrating a structure of a 3D magnetic-force line generated by a magnetic pen. FIG. 8 is a perspective view illustrating an internal structure of a magnetic force sensor.

The magnetic pen 300 may move on the X axis and the Y axis on the same plane as the magnetic force sensor 226. Depending on the case, the magnetic pen 300 may move along the Z axis vertical to an XY plane. The magnetic force sensor 226 may measure a change in a magnetic field caused by movement of the magnetic pen 300 with respect to three axes, and measurement values may be recorded.

The magnetic force sensor 226 illustrated in FIG. 8 may be a hall effect sensor and may have a structure where four hall effect electrodes 2263 are provided in orthogonal pairs in a stacked gap of a magnetic field absorber upper plate 2261 and a magnetic field absorber lower plate 2271 which absorb an external magnetic field. When the external magnetic field is applied to the magnetic field absorber upper plate 2261 and the magnetic field absorber lower plate 2271 in an X-axis direction, a hall effect induced current 2264 corresponding to an X1 position and another hall effect induced current 2264 corresponding to an X2 position may be oppositely measured. However, a Y-direction magnetic field may not be changed, and thus, a hall effect induced current 2264 corresponding to a Y1 position and another hall effect induced current 2264 corresponding to a Y2 position may be measured in the same direction.

When the external magnetic field is applied to the magnetic field absorber upper plate 2261 and the magnetic field absorber lower plate 2271 in a Y-axis direction, the hall effect induced current 2264 corresponding to the Y1 position and the other hall effect induced current 2264 corresponding to the Y2 position may be oppositely measured, and the hall effect induced current 2264 corresponding to the X1 position and the other hall effect induced current 2264 corresponding to the X2 position may be measured in the same direction.

Moreover, when the external magnetic field is applied to the magnetic field absorber upper plate 2261 and the magnetic field absorber lower plate 2271 in a Z-axis direction (a direction vertical to the XY plane), the hall effect induced currents 2264 respectively corresponding to the X1 position, the X2 position, the Y1 position, and the Y2 position may be measured in the same direction. As described above, 3D vectors of the external magnetic field may be simultaneously measured by measuring levels and directions of the hall effect induced currents 2264.

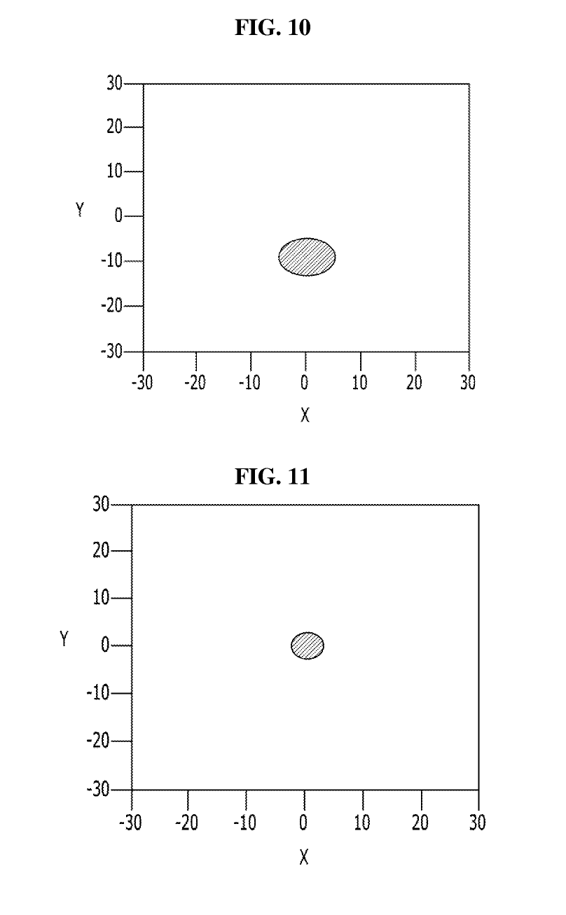

FIG. 9 is a graph showing a spatial distribution of a magnetic force in an X-axis direction generated by a magnetic pen. FIG. 10 is a graph showing a spatial distribution of a magnetic force in a Y-axis direction generated by the magnetic pen. FIG. 11 is a graph showing a spatial distribution of a magnetic force in a Z-axis direction generated by the magnetic pen.

When the magnetic pen 300 freely moves on the XY plane of the display device 200, as illustrated in FIGS. 9 to 11, X-axis, Y-axis, and Z-axis magnetic force distributions of the magnetic pen 300 may be simultaneously measured. The three-axis magnetic force distributions may be stored in the magnetic force sensor 226, and a trajectory of the magnetic pen 300 on the display device 200 may be detected by comparing the three-axis magnetic force distributions with a unique magnetic force distribution based on a spatial position of the magnetic pen 300. One magnetic pen 226 may sense the changes in a magnetic field in three axis directions, and thus, a trajectory of the magnetic pen 300 may be traced by using only one magnetic force sensor 226. However, in a case of using two or more magnetic force sensors 226, a degree of precision of detection of a position of the magnetic pen 300 is enhanced.

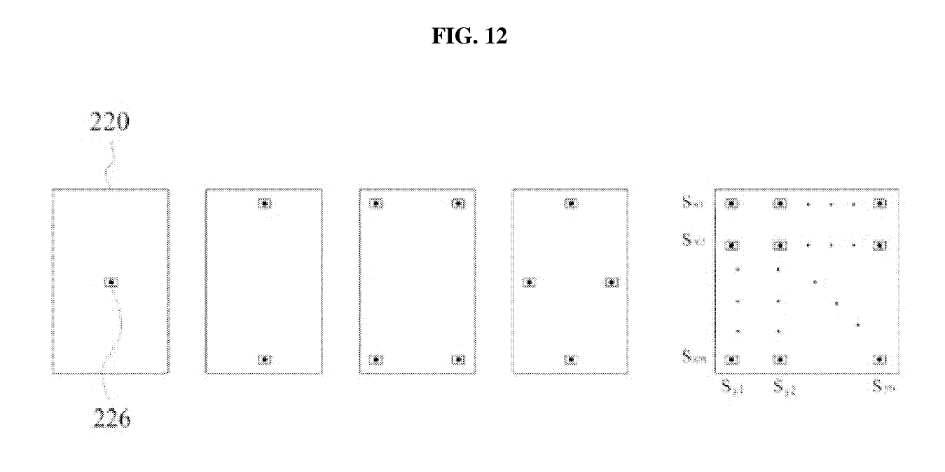

FIG. 12 is a plan view illustrating a plurality of magnetic force sensors which are arranged in parallel depending on a size of a digitizer.

As illustrated in FIG. 12, in a recognition area of the magnetic pen 300 in the display device 200, a diagonal length of the display device 200 may be 0.5 inches to 200 inches, and as the recognition area increases, a plurality of magnetic force sensors 226 may be arranged in parallel in the display device 200.

If an area of the display device 200 increases, a more number of magnetic force sensors 226 may be needed for enhancing sensing performance or a degree of accuracy. As illustrated in FIG. 12, the magnetic force sensor 226 may be generally disposed at an edge of the display device 200, but if the display device 200 has a large-size screen, a number of magnetic force sensors 226 may be provided in the touch screen.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. A touch screen integrated digitizer including a three-axis magnetic force sensor and a magnetic pen, the touch screen integrated digitizer comprising:
a display device; and
a magnetic pen,
wherein
the display device comprises:
a cover window configured to protect the display device from an external contact damage caused by a touch or writing;
a touch panel disposed on a rear surface of the cover window to sense a touch contact signal;
a liquid crystal panel disposed on a rear surface of the touch panel to output signal information;
a circuit board configured to control an input or an output of a signal to or from the touch panel, the liquid crystal panel, and a magnetic force sensor;
an internal case configured to surround a side surface and a rear surface of the circuit board and accommodate the cover window, the touch panel, and the liquid crystal panel which are sequentially stacked; and
a magnetic force sensor provided as one or more on one of the rear surface of the cover window, a front surface and the rear surface of the liquid crystal panel, a front surface and the rear surface of the touch panel, a front surface and the rear surface of the circuit board, and an inner surface of the internal case, and
the magnetic pen freely moves on the front surface of the cover window to generate a three-dimensional (3D) distribution of a magnetic force, the magnetic force sensor detects the 3D distribution of the magnetic force, and the display device visually displays a movement trajectory.

2. The touch screen integrated digitizer of claim 1, wherein the cover window is a sheet that includes a front surface and a rear surface which are flat or includes a flat surface whose a portion is bent at a curvature of 1 cm to 50 cm, and has a thickness of 0.1 mm to 10 mm.

3. The touch screen integrated digitizer of claim 1, wherein
the cover window is formed of a transparent material having a light transmittance of 85% to 95%, the transparent material being one of Pyrex glass, soda glass, alumina glass, quartz, poly methyl methacrylate (PMMA), an acryl-based polymer composite, polyethylene terephthalate (PET), or
the cover window is formed of one material of an acryl-based polymer, a vinyl-based polymer, and a terephthalate-based polymer, in which the polymer molecular binding of a surface is reinforced by applying electrons of 1 keV to 10,000 keV, ions, gamma rays to the surface.

4. The touch screen integrated digitizer of claim 1, wherein
the touch panel comprises a touch sensing electrode, which is formed of one material of indium tin oxide (ITO), silver nanoparticles, silver nanowire, and carbon nanotube which have a light transmittance of 85% to 99% and are transparent, and
an electrode supporting layer which is formed of one material of poly methyl methacrylate (PMMA), an acryl-based polymer composite, polyethylene terephthalate (PET) is covered by the front surface of the liquid crystal panel,
a lateral axis pattern layer is cross-coupled to the lateral axis supporting layer with respect to a longitudinal axis pattern layer and the longitudinal axis supporting layer.

5. The touch screen integrated digitizer of claim 1, wherein the magnetic force sensor measures magnetic forces of 0.001 Gauss to 10,000 Gauss in three axis directions of spatial orthogonal coordinates by using a hall effect, a search coil induction effect, a flux gate induction effect, and a magneto resistive effect.

6. The touch screen integrated digitizer of claim 1, wherein
the circuit board previously stores three-axis magnetic force distribution data of the magnetic pen based on front coordinates of the display device, and
the display device compares the previously stored three-axis magnetic force distribution data with a three-axis magnetic force vector measured based on a free movement of the magnetic pen to calculate a relative trajectory of the magnetic pen.

7. The touch screen integrated digitizer of claim 6, wherein
the three-axis magnetic force distribution data is a unique distribution measured by each of the one or more magnetic force sensors included in the display device,
the display device calculates an arithmetic average of trajectories of the magnetic pen sensed by two or more magnetic force sensors to enhance an accuracy of a trajectory.
